(19) United States
(12) Patent Application Publication
(10) Pub. No.: US 2011/0009237 A1
(43) Pub. Date: Jan. 13, 2011

(54) METHOD FOR REDUCING GEAR SHIFTING SHOCK OF HYBRID ELECTRIC VEHICLE

(75) Inventors: Sang Joon Kim, Seoul (KR); Sang Hee Shin, Seoul (KR)

Correspondence Address: EDWARDS ANGELL PALMER & DODGE LLP, P.O. BOX 55874, BOSTON, MA, 02205, US

(73) Assignee: HYUNDAI MOTOR COMPANY, Seoul (KR)

(21) Appl. No.: 12/624,457

(22) Filed: Nov. 24, 2009

(30) Foreign Application Priority Data
Jul. 13, 2009 (KR) 10-2009-0063307

(51) Int. Cl. B60W 10/02; F16H 61/04; B60W 20/00

(52) U.S. Cl. 477/5; 903/946; 903/945

(57) ABSTRACT

The present invention provides a method which controls the hydraulic pressure of a clutch (an engine clutch) disposed between an engine and a drive motor, thus reducing gear shifting shock and vibration. The method comprises a slip preparation step of determining that gear shifting is required and reducing the hydraulic pressure of the clutch to a preset target hydraulic pressure from a point in time at which the gear shifting is required. The method further comprises a slip maintaining step of feedback-controlling the hydraulic pressure of the clutch such that a slip rate of the clutch is maintained constant after the hydraulic pressure of the clutch reaches the target hydraulic pressure; and a clutch lock-up completing step of increasing the hydraulic pressure of the clutch, from a point in time at which the gear shifting is completed, to a maximum hydraulic pressure for making a lock-up state of the clutch.

### CROSS-REFERENCE TO RELATED APPLICATION

This application claims under 35 U.S.C. §119(a) the benefit of Korean Patent Application No. 10-2009-0063307 filed Jul. 13, 2009, the entire contents of which are incorporated herein by reference.

### BACKGROUND

(a) Technical Field

The present disclosure relates to a method for reducing gear shifting shock in a hybrid electric vehicle.

(b) Background Art

As shown in FIG. 1, a typical hybrid electric vehicle has a layout in which an engine 10, a drive motor 20 and an automatic transmission 30 are arranged in series.

In particular, the engine 10 is coupled to the drive motor 20 through a clutch 50 (generally, called an engine clutch) for transmission of power therebetween. The drive motor 20 is directly connected to the automatic transmission 30.

Furthermore, an ISG 40 (integrated starter and generator) is coupled to the engine 10 to supply rotating force to the engine 10 (in other words, to output cranking torque) when starting.

In the hybrid electric vehicle having the above construction, when the clutch 50 is in the open state, a drive shaft is operated only by the drive motor 20. When the clutch 50 is in the locked state, the drive shaft is operated by both the engine 10 and the drive motor 20.

When the hybrid electric vehicle begins to run or travels at a low speed, drive force is generated only by the drive motor 20. That is, since the efficiency of the engine 10 is lower than that of the drive motor 20 at the initial stage of the running, it is efficient for the vehicle to begin to be run using the drive motor 20 rather than using the engine 10.

After the vehicle begins to run, the ISG 40 starts the engine 10 such that the output of the engine 10 and the output of the drive motor 20 can be used at the same time.

As such, depending on necessity, the hybrid electric vehicle may run in an EV (electric vehicle) mode which uses only the rotating force of the drive motor 20 or it may run in an HEV (hybrid electric vehicle) mode which uses the rotating force of the engine 10 as its main drive force and simultaneously uses the rotating force of the drive motor 20 as the auxiliary drive force. When the ISG 40 starts the cranking of the engine 10, the EV mode is converted into the HEV mode.

The conversion between the EV mode and the HEV mode in the hybrid electric vehicle is one of the important factors that influence the drivability, the fuel efficiency and the power performance of the vehicle.

Particularly, in the case of the hybrid system of FIG. 1 including the engine 10, the drive motor 20, the automatic transmission 30, the ISG 40 and the clutch 50, it is indispensable to more precisely control the conversion between the modes, and an appropriate algorithm that can drive the vehicle in the optimal mode depending on driving conditions is required.

In the above hybrid system, the control of the clutch is an important factor in controlling the mode conversion.

For example, when converting from EV mode into HEV mode, the slip and the synchronization of the clutch must be controlled. The precision of the control of the clutch markedly affects the drivability and the power performance of the vehicle.

In particular, in a vehicle using an automatic transmission, after the current state of the clutch is chosen from among the open state, the slip state and the lock-up state, the control of the clutch, such as slip control and synchronization control, must be conducted.

Furthermore, in the case of the hybrid electric vehicle, the determination of the state of the clutch is also very important. In a vehicle having a typical manual transmission, when a driver presses the clutch pedal, the drive system is physically separated from the engine side. Thereafter, the gear is shifted. In the case of the automatic transmission, a physical slip occurs between the engine side and the drive system by a torque converter to shift the gear.

This is one method of reducing the time for gear shifting and of reducing gear shifting shock by reducing interference between elements when gear shifting.

However, the hybrid electric system shown in FIG. 1 is a system in which the clutch is installed in the automatic transmission without using a torque converter. Thus, there is no physical slip by the torque converter.

Therefore, in most hybrid electric systems, a transmission has control logic for reducing gear shifting shock and vibration by itself. However, an improved device which can reduce the time for gear shifting as well as reducing gear shifting shock and vibration is required.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention provides a method which controls the hydraulic pressure of a clutch (an engine clutch) disposed between an engine and a drive motor of a hybrid electric vehicle, thus reducing gear shifting shock and vibration generated when gear shifting, and achieving rapid gear shifting.

In one aspect, the present invention provides a method for reducing gear shifting shock of a hybrid electric vehicle, including: a) a slip preparation step of determining that gear shifting is required and reducing a hydraulic pressure of a clutch to a preset target hydraulic pressure from a point in time at which the gear shifting is required; b) a slip maintaining step of feedback-controlling the hydraulic pressure of the clutch such that a slip rate of the clutch is maintained constant after the hydraulic pressure of the clutch reaches the target hydraulic pressure; and c) a clutch lock-up completing step of increasing the hydraulic pressure of the clutch, from a point in time at which the gear shifting is completed, to a maximum hydraulic pressure for making a lock-up state of the clutch.

In a preferred embodiment, the target hydraulic pressure may be set as a value depending on engine torque and motor torque. Preferably, the target hydraulic pressure may be set as a value depending on a difference between the engine torque and the motor torque.

In another preferred embodiment, at the slip preparation step a), the hydraulic pressure of the clutch may be reduced at a constant rate from the point in time at which the gear shifting is required. The hydraulic pressure of the clutch may be reduced to the target hydraulic pressure within a preset time range from the point in time at which the gear shifting is required.

In still another preferred embodiment, at the clutch lock-up completing step c), the hydraulic pressure of the clutch may be increased at a constant rate.

The present invention having the above-construction provides the following effects.

In the method for reducing gear shifting shock according to the present invention, when slipping a clutch for gear shifting of an automatic transmission, the hydraulic pressure of the clutch is controlled appropriately. Hence, gear shifting shock and vibration can be reduced, thus improving the feeling when shifting.

Furthermore, by virtue of controlling the hydraulic pressure of the clutch, separate control operation to reduce shock applied to the transmission itself can be simplified. Therefore, the time required from the point in time at which the gear shifting begins to the point at which the gear shifting is completed can be reduced.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention, and wherein:

FIG. 1 is a view showing the construction of a typical hybrid electric vehicle;

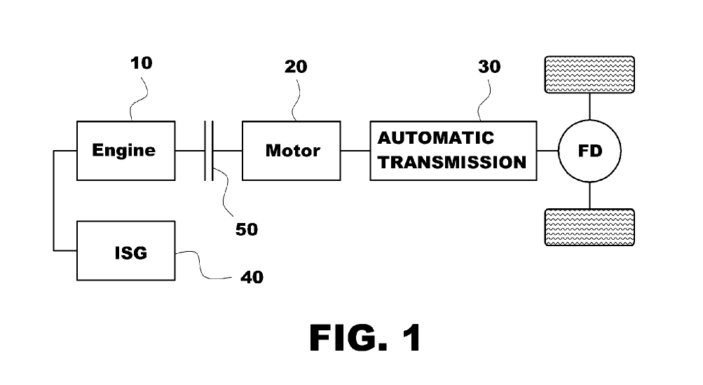

FIG. 2 is a graph illustrating a method of controlling the hydraulic pressure of a clutch when gear shifting occurs, according to the present invention; and

FIG. 3 is a flowchart of the method of controlling the hydraulic pressure of the clutch when gear shifting occurs according to the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

The present invention pertains to a method for reducing gear shifting shock of a hybrid electric vehicle. In detail, the present invention provides a method for reducing shock and vibration generated when gear shifting occurs in such a way as to control the operating hydraulic pressure of a clutch (an engine clutch) interposed between an engine and a drive motor and for achieving rapid gear shifting.

Particularly, for hybrid electric vehicles having automatic transmissions, the present invention provides a method for effectively reducing gear shifting shock using a slip of the clutch in place of a physical slip between the engine side and the drive system by the conventional torque converter.

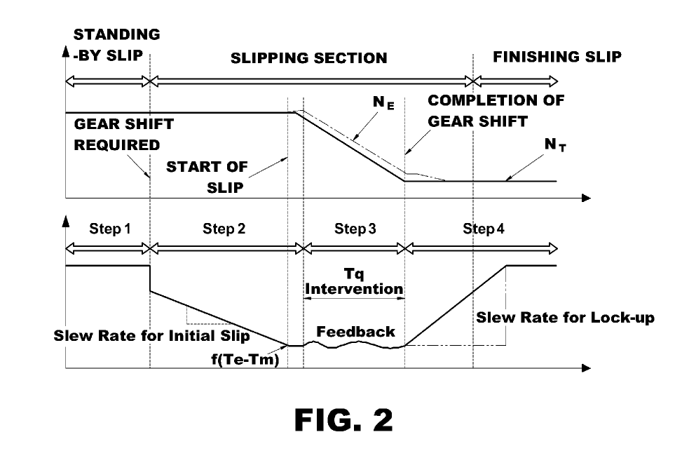

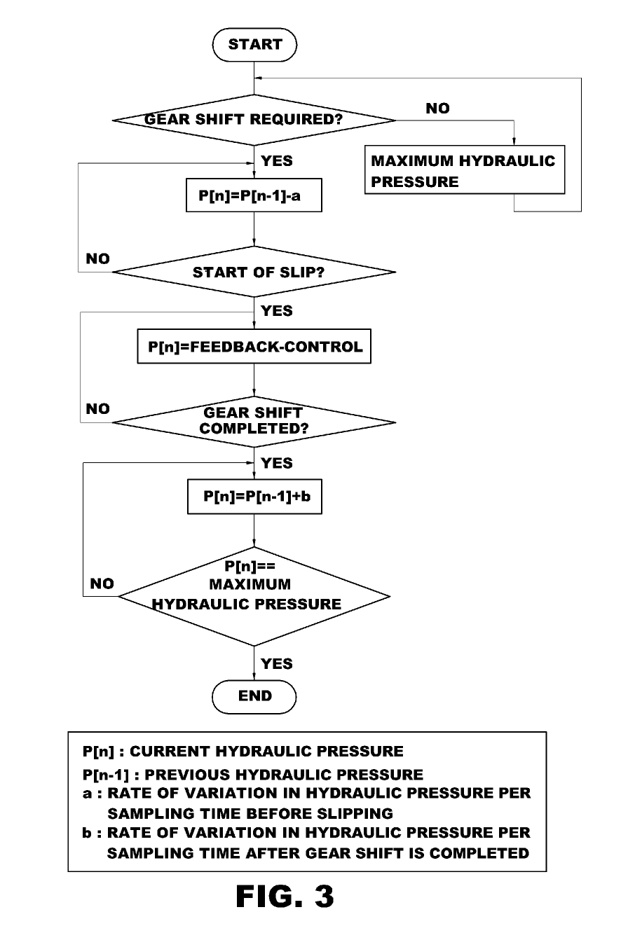

FIG. 2 is a graph illustrating a method of controlling the hydraulic pressure of the clutch when gear shifting occurs, according to the present invention. FIG. 3 is a flowchart of the method of controlling the hydraulic pressure of the clutch when gear shifting occurs according to the present invention.

In the present invention, a hybrid vehicle control unit which is the highest significant control unit, a transmission control unit which controls a transmission, and a clutch control unit which controls the clutch can function as control hosts. The process of controlling the clutch of the present invention for reducing gear shifting shock can be achieved by the clutch oil pressure control that is conducted during gear shifting under cooperation control of the hybrid vehicle control unit, the transmission control unit and the clutch control unit.

For example, the hybrid vehicle control unit determines the point at which gear shifting is required and the point at which the gear shifting is completed using signals transmitted from the transmission control unit. Furthermore, the hybrid vehicle control unit calculates a hydraulic pressure control value of the clutch on the basis of various control variables and then transmits a hydraulic pressure control signal to the clutch control unit.

Thereby, the clutch control unit controls a clutch hydraulic pressure system by the hydraulic pressure control signal of the hybrid vehicle control unit, thus controlling the hydraulic pressure of the clutch and the state of the clutch, such that it enters the open state, the slip state or the lock-up state.

Hereinafter, the control process will be explained in more detail.

In FIG. 2, at step 1, gear shifting (a slip) is standing by. Step 2 is the slip preparation step of preparing a clutch slip. At step 2, the hydraulic pressure of the clutch is gradually reduced at a constant rate. Step 3 is the slip step at which an actual clutch slip is conducted. At this step, the clutch is controlled such that the clutch slip rate is maintained constant. Step 4 is the step of completing the slip. After the gear shifting is completed, the hydraulic pressure is increased, thus entering the lock-up state.

First, at step 1, because the clutch must maintain the lock-up (integrated) state, the hydraulic pressure of the clutch is maintained at the maximum.

At step 2, the hydraulic pressure of the clutch is reduced at a constant rate from the point in time at which gear shifting is required. Here, depending on the engine torque (Te) and the motor torque (Tm), the hydraulic pressure of the clutch is reduced to a preset target hydraulic pressure [f(Te−Tm)]. Furthermore, the hydraulic pressure of the clutch is reduced at a constant rate at which the hydraulic pressure of the clutch can reach the target hydraulic pressure within a preset time range.

The target hydraulic pressure and the preset time range may be determined from data obtained through preceding tests. For example, the target hydraulic pressure can be set as a target value [f(Te−Tm)] that results from ‘a current engine torque (Te)—a current motor torque (Tm)’. The preset time range can be a time value that is previously set as a range from the point in time at which gear shifting is required to the point in time at which a slip begins.

The process of step 2 is conducted as follows. The hybrid vehicle control unit determines a target hydraulic pressure from an engine torque and a motor torque and calculates a hydraulic pressure control value such that the hydraulic pressure of the clutch is reduced at a constant rate. Thereafter the hybrid vehicle control unit outputs a hydraulic pressure control signal. Then, the clutch control unit controls the hydraulic pressure system of the clutch depending on the hydraulic pressure control signal transmitted from the hybrid vehicle control unit, thus controlling the hydraulic pressure of the clutch.

Here, the hydraulic pressure control value is calculated as a value appropriate to form a constant rate at which the hydraulic pressure of the clutch can reach the target hydraulic pressure within a preset time range.

After the hydraulic pressure of the clutch reaches the target hydraulic pressure, at step 3, a slip begins. The slip rate is maintained constant. Here, the clutch pressure is feedback-controlled such that the slip rate [N_{E}(engine speed)—N_{T}(motor speed)] is maintained as a preset target slip rate even when torque intervention occurs.

In this process, the hybrid vehicle control unit and the clutch control unit feedback-control the hydraulic pressure of the clutch in conjunction with each other such that the current slip rate is maintained constant on the basis of the engine speed (N_{E}) and the motor speed (an input speed of the transmission, N_{T}).

At step 4, from the point in time at which the gear shifting is completed, the hydraulic pressure of the clutch is gradually increased to make the lock-up state of the clutch. Here, the hydraulic pressure of the clutch is increased at a constant rate to the maximum hydraulic pressure at which the clutch enters the lock-up state.

The control process of the present invention is completed in the state where the clutch is in the lock-up state.

Referring to FIG. 3, when the gear shifting is required, the hydraulic pressure of the clutch is reduced at a constant rate. When the hydraulic pressure of the clutch reaches a target hydraulic pressure, a slip begins. The slip progresses while the hydraulic pressure of the clutch is feedback-controlled such that a slip rate is maintained constant. After the gear shifting is completed, the hydraulic pressure of the clutch is increased to the maximum hydraulic pressure at a constant rate. Thus, the clutch enters the lock-up state again.

As described above, in the present invention, the hydraulic pressure of a clutch is controlled appropriately by slipping the clutch for gear shifting of an automatic transmission, Hence, gear shifting shock and vibration can be reduced, thus improving the feeling when shifting.

Furthermore, by virtue of controlling the hydraulic pressure of the clutch, separate control operation to reduce shock applied to the transmission itself can be simplified. Therefore, the time required from a point in time at which the gear shifting begins to a point at which the gear shifting is completed can be reduced.

The invention has been described in detail with reference to a preferred embodiment thereof. However, it will be appreciated by those skilled in the art that changes may be made in this embodiment without departing from the principles and spirit of the invention, the scope of which is defined in the appended claims and their equivalents.

What is claimed is:

1. A method for reducing gear shifting shock of a hybrid electric vehicle, comprising:
a) a slip preparation step of determining that gear shifting is required and reducing a hydraulic pressure of a clutch to a preset target hydraulic pressure from a point in time at which the gear shifting is required;
b) a slip maintaining step of feedback-controlling the hydraulic pressure of the clutch such that a slip rate of the clutch is maintained constant after the hydraulic pressure of the clutch reaches the target hydraulic pressure; and
c) a clutch lock-up completing step of increasing the hydraulic pressure of the clutch, from a point in time at which the gear shifting is completed, to a maximum hydraulic pressure for making a lock-up state of the clutch.

2. The method of claim 1, wherein the target hydraulic pressure is set as a value depending on engine torque and motor torque.

3. The method of claim 2, wherein the target hydraulic pressure is set as a value depending on a difference between the engine torque and the motor torque.

4. The method of claim 1, wherein at the slip preparation step a), the hydraulic pressure of the clutch is reduced at a constant rate from the point in time at which the gear shifting is required.

5. The method of claim 4, wherein the hydraulic pressure of the clutch is reduced to the target hydraulic pressure within a preset time range from the point in time at which the gear shifting is required.

6. The method of claim 1, wherein at the clutch lock-up completing step c), the hydraulic pressure of the clutch is increased at a constant rate.
